(19) United States
(12) Patent Application Publication
(10) Pub. No.: US 2020/0232262 A1
(43) Pub. Date: Jul. 23, 2020

(54) METHOD AND SYSTEM FOR OPERATING A CLOSURE PANEL OF A VEHICLE

(71) Applicant: MAGNA CLOSURES INC., Newmarket (CA)

(72) Inventor: Marco MARLIA, Collesalvetti (IT)

(21) Appl. No.: 16/748,240

(22) Filed: Jan. 21, 2020

Related U.S. Application Data
(60) Provisional application No. 62/795,254, filed on Jan. 22, 2019.

(51) Int. Cl. E05B 81/78; B60R 11/04; B60R 25/01; B60R 25/20; B60R 25/34

(52) U.S. Cl. CPC E05B 81/78; B60R 11/04; B60R 25/01; E05B 83/36; B60R 25/34; E05B 81/77; B60R 25/2045

(57) ABSTRACT

A system and method for operating a closure panel of a vehicle. The system includes at least one optical interface unit for detecting motion of an object and a controller unit coupled to the at least one optical interface unit and in communication with an actuator for operating the closure panel. The controller unit is configured to monitor the at least one optical interface unit to detect the motion of the object. The controller unit determines whether the motion of the object matches a predetermined touch or gesture command. The controller unit is also configured to control the actuator in response to the touch or gesture matching the predetermined touch or gesture command.

### CROSS-REFERENCE TO RELATED APPLICATION

This utility application claims the benefit of U.S. Provisional Application No. 62/795,254 filed Jan. 22, 2019. The entire disclosure of the above application is incorporated herein by reference.

### FIELD

The present disclosure relates generally to entry systems for vehicles. More particularly, to a system for operating a closure panel of a vehicle with proximity and gesture detection.

### BACKGROUND

This section provides background information related to the present disclosure which is not necessarily prior art.

Many passenger vehicles and trucks are now equipped with keyless entry systems alone or in combination with a traditional mechanical-type (i.e., key) entry system. For example, a vehicle-mounted keyless entry system with a touch device, such as a keypad, can be mounted to the vehicle which enables an authorized user to enter a passcode consisting of a sequence of alpha or numerical codes. Upon verification of the passcode, an on-board controller unit controls operation of a power-operated door latch mechanism. The keypad may also be used to control other vehicle operational functions such as, for example, power release of the gas tank cover or the tailgate lift system following entry and verification of the correct passcode. Some keypads use pushbuttons and/or switches or capacitive sensors to enter the authentication code.

While such keyless entry systems have found widespread applications in vehicle door systems (e.g., passenger doors, tailgates and closure doors), a need exists to continually advance the art and address known deficiencies associated with conventional keyless entry systems. For example, a need to be addressed includes limiting electrical power usage associated with “false activation” of the keypad caused by inadvertent inputs to the keypad. Such inadvertent inputs can, for example, be caused by rain, flying debris or carwash spray jets contacting the capacitive sensors associated with the keypad. As a byproduct of solving such deficiencies, inadvertent operation of the door latch mechanism will be prevented to maintain the door in its proper locked or unlocked state.

A need therefore exists for an improved method and system for operating a closure panel of a vehicle. Accordingly, a solution that addresses, at least in part, the above-noted shortcomings and advances the art is desired.

### SUMMARY

This section provides a general summary of the present disclosure and is not intended to be interpreted as a comprehensive disclosure of its full scope or all of its features, aspects and objectives.

It is an aspect of the present disclosure to provide a system for operating a closure panel of a vehicle. The system includes at least one optical interface unit for detecting motion of an object. The system also includes a controller unit coupled to the at least one optical interface unit and in communication with an actuator for operating the closure panel. The controller unit is configured to monitor the at least one optical interface unit to detect the motion of the object. The controller unit also is configured to determine whether the motion of the object matches a predetermined touch or gesture command. The controller unit controls the actuator in response to the touch or gesture matching the predetermined touch or gesture command.

According to another aspect of the disclosure, a method of operating a closure panel of a vehicle is also provided. The method includes the step of monitoring at least one optical interface unit for motion of an object. The method continues with the step of determining whether the motion of the object matches a predetermined touch or gesture command. Next, the method includes the step of controlling an actuator of the closure panel in response to the touch or gesture matching the predetermined touch or gesture command.

According to yet another aspect of the disclosure, there is provided a system for operating a closure panel of a vehicle, including at least one optical interface unit for monitoring the light from a field of view, and a controller unit coupled to the at least one optical interface unit and in communication with an actuator for operating the closure panel, the controller unit configured to monitor the at least one optical interface unit, determine a black out condition of the optical interface unit, and control the actuator in response to determining the blackout condition of the optical interface unit.

According to yet another aspect of the present disclosure there is provided a system for operating a device, including at least one optical interface unit for monitoring the light from a field of view, and a controller unit coupled to the at least one optical interface unit and in communication with the device, the controller unit configured to monitor the at least one optical interface unit, determine a black out condition of the optical interface unit, and control the device in response to determining the black out condition of the optical interface unit.

These and other aspects and areas of applicability will become apparent from the description provided herein. The description and specific examples in this summary are intended for purpose of illustration only and are not intended to limit the scope of the present disclosure.

### DRAWINGS

The drawings described herein are for illustrative purposes only of selected embodiments and not all implementations, and are not intended to limit the present disclosure to only that actually shown. With this in mind, various features and advantages of example embodiments of the present disclosure will become apparent from the following written description when considered in combination with the appended drawings, in which:

FIG. 1 is a partial perspective view of a motor vehicle with a closure panel equipped with a latch assembly according to aspects of the disclosure;

FIG. 2 is a partial perspective side view of the motor vehicle equipped with at least one optical interface unit of a system for operating the closure panel of the motor vehicle and another closure panel with latch assembly according to aspects of the disclosure;

FIG. 2A is a diagrammatic view of the front passenger door shown in FIG. 2, with various components removed for clarity purposes only, in relation to a portion of the vehicle body and which is equipped with a power door actuation system and at least one optical interface unit in accordance with an illustrative example;

FIG. 2B is an isometric view of a power swing door actuator of FIG. 2A constructed according to an illustrative example of a vehicle system to be controlled;

FIG. 3 illustrates additional details and other possible mounting locations of the at least one optical interface unit of the system according to aspects of the disclosure;

FIGS. 4-7 show the system including a controller unit in communication with the at least one optical interface unit and an actuator along with a field of view of the at least one optical interface unit while detecting motion of an object according to aspects of the disclosure;

FIG. 8 illustrates an exploded view of an illustrative embodiment of an at least one optical interface unit;

FIG. 9 illustrates an infrared photometric sensor of an at least one optical interface unit, according to aspects of the disclosure;

FIG. 10 illustrates a sensor microcontroller of the driver microcontroller and accent LED printed circuit board of at least one optical interface unit, according to aspects of the disclosure;

FIGS. 11 to 14 illustrate a series of progressive views showing an interaction of a hand with the at least one optical interface unit of FIGS. 4 to 7, in accordance with an illustrative operational example;

FIG. 15 illustrates a gesture interaction of a hand with the at least one optical interface unit of FIGS. 4 to 7, in accordance with an illustrative operational example;

FIGS. 16A to 16C illustrate optical sensor data plotted on graphs representing different motions or proximities of a hand interacting with an at least one optical interface unit causing changes in light intensity detected by the at least one optical interface, in accordance with an illustrative operational example;

FIG. 17 illustrates optical sensor data plotted on a graph representing an interaction of a hand swiping gesture in front of the an at least one optical interface unit causing changes in light angle detected by the at least one optical interface, in accordance with an illustrative operational example;

FIGS. 18 to 21 illustrate different interactions of a hand approaching an at least one optical interface unit causing different types of black out conditions of the at least one optical interface, in accordance with an illustrative operational example; and

FIGS. 22 to 25 illustrate algorithms in the form of method flow charts for execution by a control unit of the system of FIG. 2, in accordance with an illustrative embodiment.

### DETAILED DESCRIPTION

In the following description, details are set forth to provide an understanding of the present disclosure. In some instances, certain circuits, structures and techniques have not been described or shown in detail in order not to obscure the disclosure.

In general, a system and method for operating a closure panel of a motor vehicle are disclosed herein. The system and method of this disclosure will be described in conjunction with one or more example embodiments. However, the specific example embodiments disclosed are merely provided to describe the inventive concepts, features, advantages and objectives will sufficient clarity to permit those skilled in this art to understand and practice the disclosure.

FIG. 1 is a perspective view of a vehicle 10 that includes a vehicle body 12 and at least one closure panel 14 (e.g., rear driver-side door 14). The rear driver-side door 14 includes a latch assembly 16 that is positioned on an edge face 17 of the door 14. The latch assembly 16 is releasably engageable with a striker 18 disposed on a rearward surface 19 of a rear opening 20 of the vehicle body 12 to releasably hold the door 14 in a closed position. The door 14 has an outside door handle 21 and an inside handle 22 for opening the latch assembly 20 (i.e., for releasing the latch assembly 20 from the striker 28) to open the door 14 by a user from outside or inside of the vehicle 10. A lock knob 23 is shown and provides a visual indication of a lock state of the latch assembly 16 and is operable to change the lock state between an unlocked position and a locked position.

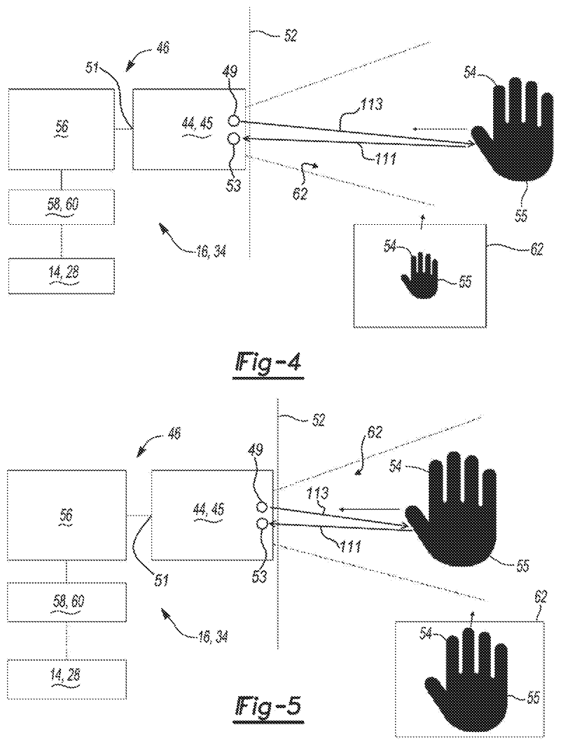

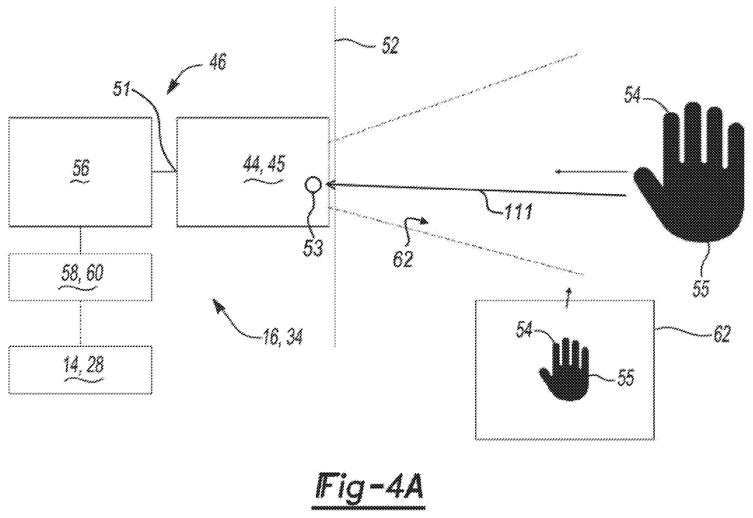

It is recognized that the latch assembly 16 can be configured as any type of latch (e.g., manual release, power release, with or without cinch functionality, etc.). The latch assembly 16 can also have a presentment mechanism (i.e., to present the closure panel by slightly it) as latch components mounted on a housing of the latch assembly 16 (e.g., within an interior of a housing of the latch assembly 16). Further, the latch assembly 16 can also use common or separate actuators 58, 60 (FIG. 4) (e.g., electric motor) to operate the presentment mechanism and other latch components (e.g., ratchet) to provide for unlatching or a cinching operation (i.e., soft close).

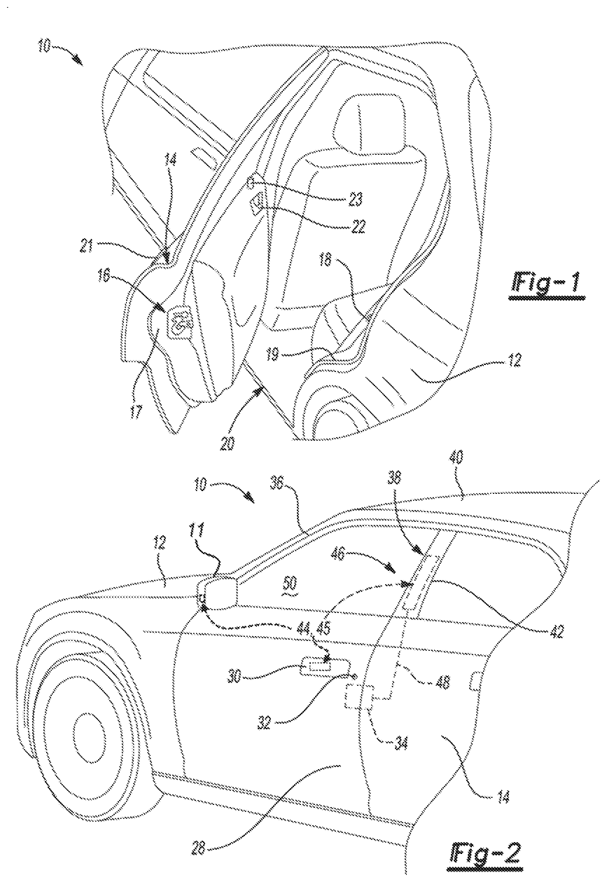

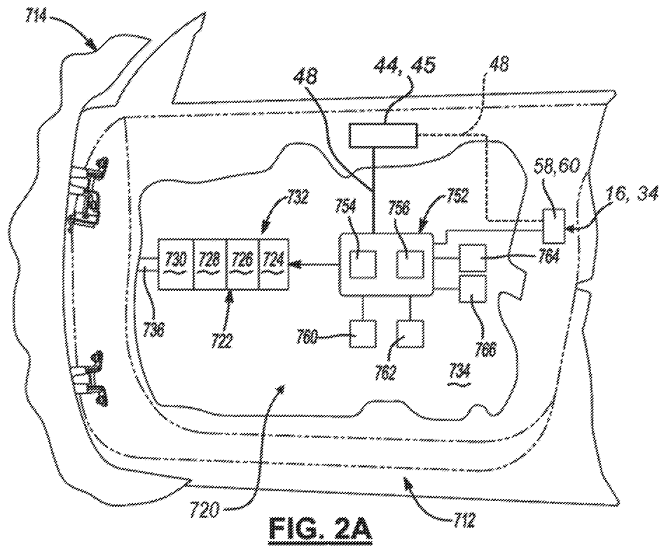

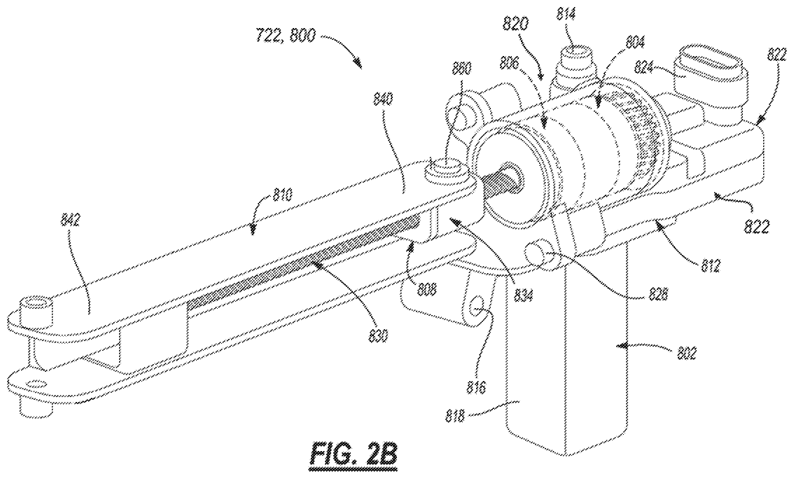

Referring to FIG. 2, a side view of the motor vehicle 10 is shown partially cut away to include a front driver-side door 28 and the rear driver-side door 14 which both provide access to a passenger compartment. Front driver-side door 28 is shown to include a door handle 30 and a key hole 32 provided for otherwise conventional locking and unlocking of another latch assembly 34 mounted within front driver-side door 28. Movement of door handle 30 functions to release front driver-side door 28 for movement relative to the vehicle body 12 when the latch mechanism is unlocked, similar to the operation of the door handles 21, 22 for the rear driver-side door 14 discussed above. Motor vehicle 10 is shown to also include an A-pillar 36, a B-pillar 38 and a roof portion 40.

Referring to FIG. 2A, in addition to FIG. 2, there is shown a power door actuation system 720 including a power swing door actuator 722 configured to include an electric motor 724, a reduction geartrain 726, a slip clutch 728, and a drive mechanism 730 which together define a power assembly 732 that is mounted within an interior chamber 734 of door 28 shown as door 712 in FIG. 2A. Power swing door actuator 722 further includes a connector mechanism 736 configured to connect an extensible member of drive mechanism 730 to vehicle body 12, 714. As also shown, an electronic control module 752 is in communication with electric motor 724 for providing electric control signals thereto. Electronic control module 752 can include a microprocessor 754 and a memory 756 having executable computer readable instructions stored thereon. Although not expressly illustrated, electric motor 724 can include Hall-effect sensors for monitoring a position and speed of vehicle door 712 during movement between its open and closed positions. For example, one or more Hall-effect sensors may be provided and positioned to send signals to electronic control module 752 that are indicative of rotational movement of electric motor 724 and indicative of the opening speed of vehicle door 28. 712, e.g., based on counting signals from the Hall-effect sensor detecting a target on a motor output shaft. As is also schematically shown in FIG. 2A, electronic control module 752 can be in communication with a remote key fob 760 or an internal/external handle switch 762 for receiving a request from a user to open or close vehicle door 712. Put another way, electronic control module 752 receives a command signal from either remote key fob 760 and/or internal/external handle switch 762 to initiate an opening or closing of vehicle door 712. Electronic control module 752 may also be in communication with at least one optical interface unit 44, 45 via a communication link 48 (e.g. vehicle bus, electrical wires, wireless link) for receiving a command signal therefrom as will be described in more details herein below. Upon receiving a command, electronic control module 752 proceeds to provide a signal to electric motor 724 in the form of a pulse width modulated voltage (for speed control) to turn on motor 724 and initiate pivotal swinging movement of vehicle door 712. While providing the signal, electronic control module 752 may optionally also obtain feedback from the Hall-effect sensors of electric motor 724 to ensure that a contact obstacle has not occurred for example or for controlling door opening speed using feedback control techniques. If no obstacle is present, motor 724 will continue to generate a rotational force to actuate spindle drive mechanism 730. Once vehicle door 712 is positioned at the desired location, motor 724 is turned off and the “self-locking” gearing associated with gearbox 726 causes vehicle door 712 to continue to be held at that location. A sensor 764 maybe also provided in communication with electronic control module 752 to assess if an obstacle, such as another car, tree, or post, is near or in close proximity to vehicle door 712 for providing obstacle detection functionality. If such an obstacle is present, sensor 764 will send a signal to electronic control module 752, and electronic control module 752 will proceed to turn off electric motor 724 to stop movement of vehicle door 712, and thus prevent vehicle door 712 from hitting the obstacle. This provides a non-contact obstacle avoidance system. In addition, or optionally, a contact obstacle avoidance system can be placed in vehicle 710 which includes a contact sensor 766 mounted to door 28, 712, such as in association with molding component, and operable to send a signal to controller 752. One illustrative example of a power swing door actuator and system is disclosed in U.S. Pat. No. 10,378,263 entitled “Power swing door actuator with articulating linkage mechanism”, the entire contents of which are incorporated herein in its entirety by reference. Other types of power swing door actuators are however recognized as employable in conjunction with the teachings herein. For example and with reference to FIG. 2B in addition to FIG. 2A, a power swing door actuator 722, also referred to in FIG. 2B using reference numeral 800, is shown to generally include an electric motor 802, a reduction geartrain unit 804, a slip clutch unit 806, a spindle drive mechanism 808, and a linkage mechanism 810. Power actuator 800 also includes a mounting bracket 812 having one or more mounting apertures 814, 816 configured to receive fasteners (not shown) for securing bracket 812 to the vehicle door 28, 712 between the inner and outer panels thereof. A motor housing 818 associated with electric motor 802 is secured to mounting bracket 812. Likewise, a clutch housing 820 is secured to mounting bracket 812 and is configured to enclose geartrain unit 804 and clutch unit 806. An integrated controller unit 822 is also provided in associated with actuator 800 and may include a printed circuit board (not shown) and electronic circuitry and components required to control actuation of electric motor 802, as well as a plug-in connector 824 configured to provide electrical power to actuator 800. Finally, an elongated drive housing 826 is shown connected via fasteners 828 to clutch housing 820. While not limited thereto, mounting bracket 812 may be integrated with clutch housing 820 into a rigid mounting component configured to permit attachment thereto of motor housing 818, drive housing 826 and controller unit 822 to provide a compactly packaged actuator arrangement. Electric motor 802 includes a rotary output shaft driving an input gear component of geartrain unit 804. An output gear component of geartrain unit 804 drives an input clutch member of clutch unit 806 which, in turn, drives an output clutch member of clutch unit 806 until a predetermined slip torque is applied therebetween. The output clutch member of clutch unit 806 drives an externally-threaded leadscrew 830 associated with spindle drive mechanism 808. A first end of leadscrew 830 is rotatably supported by a first bearing (not shown) within geartrain housing 820 while a second end of leadscrew 830 is rotatably supported in a bushing mounted in linkage mechanism 810. Spindle drive mechanism 808 also includes an internally-threaded drive nut 834 in threaded engagement with externally-threaded leadscrew 830. Linkage mechanism 810 is generally configured to have a first end segment 840 pivotably connected to drive nut 834 and a second end segment 842 pivotably coupled the vehicle body 12. This incorporation of an articulable linkage mechanism 810 between spindle drive mechanism 808 and the vehicle body accommodates swinging motion of the vehicle door 880 upon movement between its fully-closed and fully-open positions while permitting direct fixation of power swing door actuator 800 within a smaller internal packaging portion of the vehicle door as further described in details in U.S. Pat. No. 10,378,263.

In the example shown in FIG. 2, the B-pillar 38 is covered by a cover plate assembly, such as an applique 42. At least one optical interface unit 44, 45 of a system 46 for operating the closure panel 14, 28 (e.g., door 14, 28) of the vehicle 10 of the present disclosure is, for example, mounted to B-pillar 38 within cover plate assembly or applique 42 at the location identified by the dashed lines. The optical interface unit 44, 45 may, for instance, be mounted between a structural portion of B-pillar 38 and cover plate assembly or applique 42 and be in communication with the latch assembly 34 through communication link 48. Other mounting positions of the at least one optical interface unit 44, 45 are possible, such as on a liftgate, or decklid.

Such an optical interface unit may be used as part of or in conjunction with an example touchless keyless entry keypad disclosed in U.S. Pat. No. 8,400,265, the entire disclosure of which is herein incorporated by reference. As disclosed in the '265 patent, a plurality of proximity sensors, such as capacitive sensors, are used as the code input interfaces associated with the keypad. Nevertheless, it is desirable to avoid false activation of such a keypad caused by inadvertent inputs, for example, caused by rain, flying debris or carwash spray jets contacting the capacitive sensors.

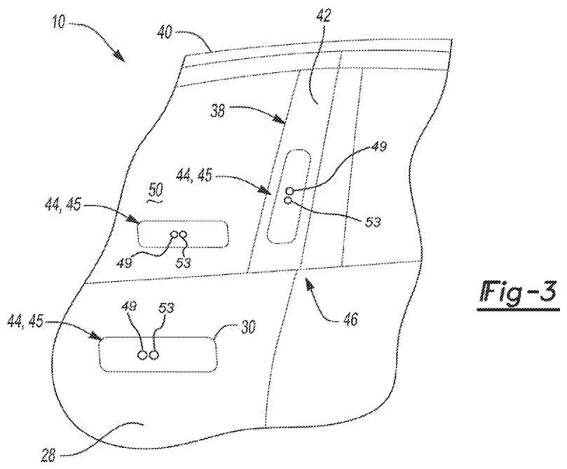

FIG. 3 illustrates additional details and other possible mounting locations of the at least one optical interface unit 44, 45 of the system 46. As discussed, the at least one optical interface unit 44, 45 could be disposed in the applique 42 or the B-pillar 38 of the motor vehicle 10. Similarly, the at least one optical interface unit 44, 45 could be installed in the handle 30 of the front driver-side door 28. Alternatively or in addition, the at least one optical interface unit 44, 45 can be disposed behind a window 50 of the front driver-side door 28. In other words, the at least one optical interface unit 44, 45 is disposed behind a surface 52 of the vehicle 10 chosen from the group consisting of the window 50 of the vehicle 10, the applique 42 attached to the vehicle 10, or an exterior of the handle 30 of the vehicle 10. Nevertheless, other mounting locations are contemplated.

As best shown in FIGS. 4-7, the system 46 disclosed herein includes the at least one optical interface unit 44, 45 for detecting motion of an object 54, 55, illustrated as a finger and a hand respectively as an example only. The optical interface unit 44, 45 may be a photometric sensor as an illustrative example, such as for example the Analog Devices'™ ADUX1020 configured with integrated signal and data processing functionalities and circuitry for detecting the motion and/or proximity of the object 54, 55 by detecting the characteristics of light 111 in a field of view 62 adjacent the optical interface unit 44, 45 and for outputting a communication via a sensor output 51 in the form of an electrical signal related to the detected object 54, 55. The optical interface unit 44, 45 may in an exemplary configuration detect the object 54, 55 based on the angle of the light 111 received by the optical interface unit 44, 45, and for example as received by an optical sensor 53 of the optical interface unit 44, 45, with the light 111 having been reflected off of the object 54, 55, and may also receive of the angle of light 111 received by the optical interface unit 44, 45 relating to also background objects or environment. The optical interface unit 44, 45 may in another exemplary configuration also or additionally detect the object 54, 55 based on the intensity of the light 111 received by the optical interface unit 44, 45 as having been reflected off of the object 54, 55, and may also receive light 111 received by the optical interface unit 44, 45 relating to background objects or environment which may be at a low or insignificant intensity level compared to that received by reflection off of from the object 54, 55. While reference to characteristics of detected light such as light intensities and/or received light angles are described herein for illustratively describing operation of the at least one optical interface unit 44, 45 for detecting motion of the object 54, 55, other characteristics of received or detected light, may be employed for detecting motion of the object 54, 55. For example, the at least one optical interface unit 44, 45 may be configured to detect infrared heat radiation from the object 54, 55. The optical interface unit 44, 45 is illustratively shown in FIGS. 4 to 7 configured as a reflective-type photoelectric sensor including a source of illumination 49, such as a light emitting device (LED) such as a light emitting diode, for illuminating the field of view 62 adjacent the optical interface unit 44, 45 with generated light 113 intended for reflection off of the object 54, 55. The optical interface unit 44, 45 may be configured to receive light 111, for example the reflected transmitted light 113, in various spectral ranges including without limitation the visible light spectrum and non-visible light spectrum such as the infrared light (IR) spectrum, as examples, as having been generated and transmitted by the source of illumination 49. The source of illumination 49 may be configured and controlled to emit the electromagnetic radiation, as referred to as the light, in different desired spectrums, for example the source of illumination 49 may be an infrared (IR) light emitting diode configured to emit light in the infrared spectrum. In another alternate configuration, as seen in FIG. 4A, the source of illumination 49 may not be provided with the optical interface unit 44, 45 and optical sensor 53 may be configured to detect light 111 reflected from, or generated by, the object 54, 55 as having originated from another source. In an alternate configuration, the optical interface unit 44, 45 may be configured as an image sensor, such as a Complementary Metal-Oxide-Semiconductor (CMOS) image sensor, as an illustrative example for capturing light as image data of the field of view 62 which may be processed using image processing techniques and algorithms for detecting motion and/or gestures of the object 54, 55, examples of which are described herein below in more detail.

The system 46 also includes a controller unit 56 coupled to the at least one optical interface unit 44, 45 at the sensor output 51 for receiving sensor data, for example via an 12C interface communication signal line or bus, and in communication with an actuator 58, 60 for operating the closure panel 14, 28 (e.g., through communication link 48). The controller unit 56 can, for example, be a microprocessor coupled to a memory storing instructions for operation. The controller unit 56 along with the at least one optical interface unit 44, 45 may be integrated in a single unit, or the controller unit 56 can instead be separate from or remotely disposed relative to the at least one optical interface unit 44, 45 (e.g., part of the latch assembly 16, 34, or as part of electronic control module 752, as examples). The actuator 58, 60 can be a latch actuator 58 (e.g., of latch assembly 16, 34) for latching and unlatching the closure panel 14, 28 of the vehicle 10 relative to the body 12 of the vehicle 10. Alternatively, the actuator 58, 60 can be a lock actuator 60 for locking and unlocking the closure panel 14, 28 of the vehicle 10 relative to the body 12 of the vehicle 10. An example of a latch assembly which may employed in conjunction with the present disclosure is as described in U.S. Pat. No. 8,141,916, entitled “Global Side Door Latch”, the entire disclosure of which is incorporated herein by reference in its entirety. The actuator 58, 60 may alternatively be a power swing door actuator, such as power swing door actuator 722, 800 described herein above. The latch assembly and door actuator are provided as illustrative examples of a vehicle system which may be controlled in conjunction with the at least one optical interface unit 44, 45. Other types of vehicle systems include a vehicle engine start button, an inside door lock, an infotainment system, or other systems having a button interface in the automotive space. Or course the teachings herein may be also applied to non-automotive technologies, such as cellular phones as but one example. The at least one optical interface unit 44, 45 may be configured as a dual use optical device, for example it may be configured in one mode of operation for obstacle detection purposes as described above, and may also be configured for access control or activation of a vehicle system employing the same optical device.

In either case, the controller unit 56 is configured to monitor the at least one optical interface unit 44, 45 to detect the motion of the object 54, 55 by receiving a signal via the sensor output 51. For example, the controller unit 56 may be configured to monitor the sensor output 51 in a push mode whereby the controller unit 56 may be operating in a sleep or low power mode, and the at least one optical interface unit 44, 45 independently pushes signals or data to be received by the controller unit 56 whereby the controller unit 56 reacts in response to the received signal. For example, and with more details herein below, the at least one optical interface unit 44, 45 may be configured to push interrupt signals in response to detecting a light condition such as a detected motion of the object 54, 55 based on detected changes in light angle reflected off of the object 54, 55 or in response to detecting a light condition such as a detected motion of the object 54, 55 based on detected changes in light intensities reflected off of the object 54, 55. For example, the controller unit 56 may be configured to monitor the sensor output 51 in a pull mode whereby the controller unit 56 may be operating in a wake or active mode, and the at least one optical interface unit 44, 45 transmits signals or data to the controller unit 56 in response to a request received by the at least one optical interface unit 44, 45 from the controller unit 56 (e.g. in response to a proximity detected FOB 760 received by controller 752 configured as the controller unit 56 whereby the at least one optical interface unit 44, 45 may react in response to the received signal request and transition from a low-power standby mode to an active detection mode. The controller unit 56 also is configured to determine whether the motion of the object 54, 55 matches a predetermined touch or gesture command. For example, controller unit 56 may be configured to execute an algorithm stored in a memory for determining a sequence of change(s) in direction of the object 54, 55 using the received sensor data, for example determining any directional changes of the object 54, 55 or a rate of positional change of the object 54, 55 based on the detected changes in the angle of the light 111 and/or the detected intensity of the light 111 over a period of time, non-limiting illustrative examples of which are described herein below. The controller unit 56 controls the actuator 58, 60 in response to the touch or gesture matching the predetermined touch or gesture command (e.g., to unlock, unlatch, and/or open the closure panel 14, 28).

According to an aspect, the at least one optical interface unit 44, 45 is an infrared proximity sensor 44 or camera 45 having a field of view 62. Thus, the controller unit 56 is configured, for example, to track an increasing obscuring of the field of view 62 over time. Consequently, the controller unit 56 can discern a pattern of the object 54, 55 chosen from the group consisting of a finger 54, a hand 55, or a gesture (e.g., sequence of movements of the hand 55) and therefore mitigate false triggering due to environmental factors (e.g., snow, leaves, water). While the at least one optical interface unit 44, 45 is described herein as an infrared proximity sensor 44 or camera 45, it should be appreciated that other types of sensing capable of monitoring objects 54, 55 in the field of view 62 may be used instead.

In more detail, the controller unit 56 is further configured to monitor the field of view 62 of the infrared proximity sensor 44 or camera 45 to detect the motion of the object 54, 55. The controller unit 56 is also configured to determine a percentage of the field of view 62 obscured by the object 54, 55 and determine whether the percentage of the field of view 62 obscured by the object 54, 55 exceeds a predetermined obscurity threshold (e.g., 50% of the field of view 62). The controller unit 56 then activates the actuator 58, 60 (e.g., to unlatch or unlock door 14, 28) in response to the percentage of the field of view 62 obscured by the object 54, 55 exceeding the predetermined obscurity threshold.

According to another aspect, the at least one optical interface unit 44, 45 is the camera 45 that is configured to capture imaging of the field of view 62. So, for example, the controller unit 56 is further configured to determine a first brightness level of an image captured by the camera 45 at a first time. The controller unit 56 is additionally configured to determine a second brightness level of another image captured by the camera 45 at a second time and determine whether the first brightness is greater than the second brightness. The controller unit 56 is further configured to determine whether the second brightness is greater than a predetermined brightness threshold. Then, the controller unit 56 activates the actuator 58, 60 in response to determining that the first brightness is greater than the second brightness and determining the second brightness is greater than the predetermined brightness threshold.

In addition, the controller unit 56 is further configured to filter (e.g., digitally) the imaging captured by the camera 45 to avoid false control of the actuator 58, 60. The controller unit 56 can additionally be configured to analyze the imaging captured by the camera 45 to determine three dimensional light intensity data corresponding to the motion of the object 54, 55 or the object 54, 55 itself. The controller unit 56 can then determine whether the three dimensional light intensity data matches the predetermined touch or gesture command.

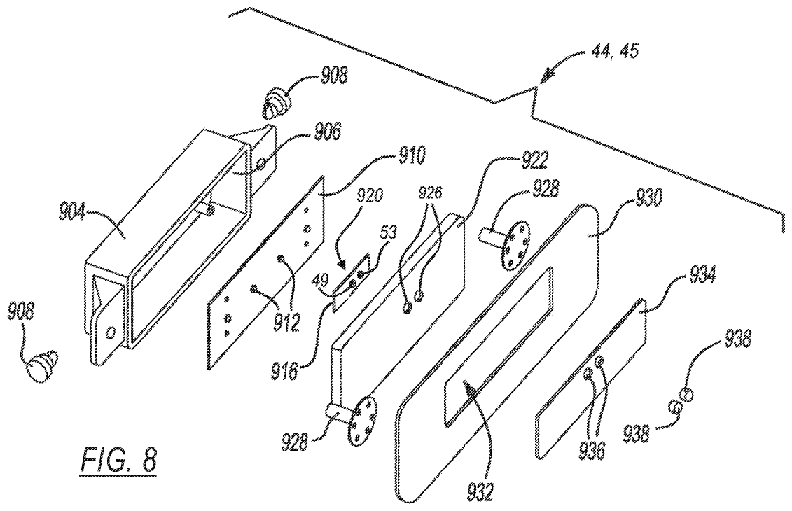

Now referring to FIG. 8, according to aspects of the disclosure the at least one optical interface unit 44, 45 can include a housing 904 defining a compartment with at least one wiring opening 906 for the passage of wiring, such as for communication line 48. The at least one optical interface unit 44, 45 may be positioned at various positions on the vehicle 10, for example it may be positioned in the front and rear side door handles 30, in an appliqué such as for example in an applique 42 of the swing door 28, 712 or a B-pillar 38, in the side door mirror 11, behind a window of the motor vehicle 10, or at other positions on the vehicle door, interior or exterior to the vehicle 10. A driver microcontroller and accent LED printed circuit board 910 is disposed within the compartment of the housing 904 and may include a plurality of multi-color LEDs 912 disposed thereon (e.g., on a first side of the driver microcontroller and accent LED printed circuit board 910) for providing feedback illumination and/or localization illumination to a user for proper positioning of the object 54, 55 in the field of view 62. A sensor microcontroller 914 (see FIG. 10) may be disposed thereon (e.g., on a second side of the driver microcontroller and accent LED printed circuit board 910). The at least one optical interface unit 44, 45 also includes an infrared sensor printed circuit board 916 that is electrically coupled to the driver microcontroller and accent LED printed circuit board 910 (e.g., to communicate via I²C communications). Boards 910, 916 may also be provided as a single integrated printed circuit board configuration, in addition to the illustrated distributed photometric board configuration. The infrared sensor printed circuit board 916 includes a sensor LED 49, such as an IR light emitting diode, and the at least one sensor 53, illustratively an infrared sensor (e.g., a photometric sensor for dual mode gesture and proximity detection as an example). A cover plate 922 may be provided to extend over the driver microcontroller and accent LED printed circuit board 910 and the infrared sensor printed circuit board 916 and defines a plurality of openings (not shown) for allowing light from the plurality of multi-color LEDs 912, if provided, of the driver microcontroller and accent LED printed circuit board 910 to pass through the cover plate 922. The cover plate 922 additionally defines sensor openings 926 each aligned with the sensor LED 49 and the infrared photometric sensor 53, respectively. A plurality of studs 928 are disposed at opposite ends of the cover plate 922. A sheet metal plate 930 defining a central opening 932 extends over the cover plate 922 and an A-surface panel 934, for example defining the surface 52, is disposed in the central opening 932. The A-surface panel 934 defines a pair of panel openings 936 aligned with the sensor openings 926 and in which a plurality of infrared transmissive covers 938 are disposed. Thus, gesture and proximity detection by the infrared photometric sensor 53 is possible, since the plurality of infrared transmissive covers 938 are infrared transparent. It should be appreciated that the infrared transmissive covers 938 can be made of any material that enables infrared transmission. Nevertheless, a “focusing” lens is not necessary, as may be needed if the optical unit 45 as a camera is utilized. The at least one optical interface unit 44, 45 outputs light as defined by the openings 926, 936 of the cover plate 922 and surface panel 934, if configured so as to illuminated the field of view 62.

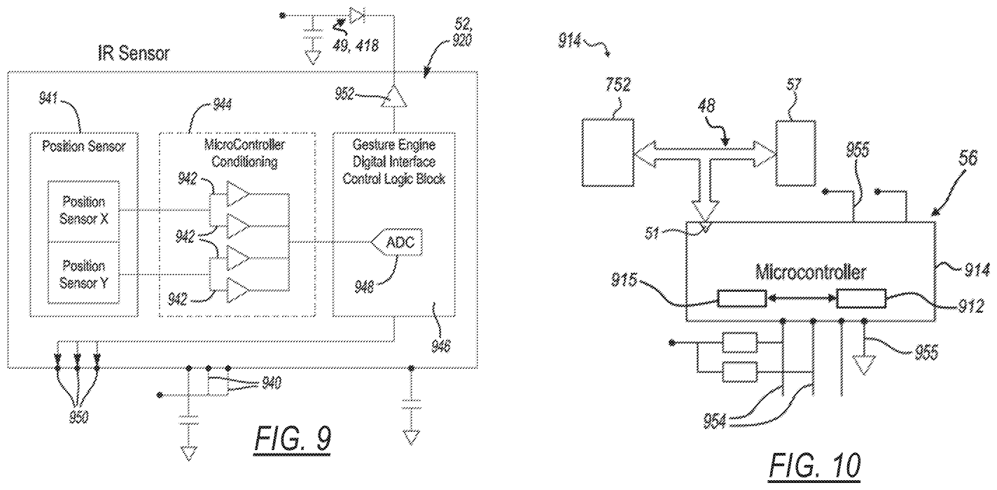

Now referring to FIG. 9, the infrared photometric sensor 53 of the infrared sensor printed circuit board 916 is shown in more detail using reference number 920 and provides for the sensing of gestures and proximity of objects 54, 55 to the infrared photometric sensor 53. The infrared photometric sensor 53 includes a plurality of sensor connections 940 (e.g., to power and ground) and a position sensor 941 having four channels 942 which are coupled to a signal conditioning block 944 from which angle and intensity information about the light 111 may be determined. The signal conditioning block 944 couples to a gesture engine digital interface control logic block 946 through a sensor analog-digital-convertor (ADC) 948. The gesture engine digital interface control logic block 946 provides a plurality of sensor outputs 950. These outputs, for example, can include a serial data and serial clock (e.g., for I²C communication). The infrared photometric sensor 920 also includes an LED driver 952 for driving an LED (e.g., sensor LED 918). The infrared photometric sensor 920 measures the intensity of reflected infrared light 111 (e.g., from sensor LED 918) and can determine the angular orientation of the reflected infrared light 111 within the field of view 62 of the infrared photometric sensor 920. The gesture engine digital interface control logic block 946 may be configured for determining a gesture using the detected angular orientation of the reflected infrared light 111 and/or using the detected intensity of the reflected infrared light 111 and output an interrupt to controller unit 56 indicative of such a determination according to one possible configuration of the system 46. The gesture engine digital interface control logic block 946 may be therefore programmed accordingly for making such determinations which may include for example calculating a change in the angle of the reflected infrared light 111 over time to determine a change in direction of the object 54, 55 e.g. from left to right, right to left, up to down, down to up, or a more complex combination thereof. The gesture engine digital interface control logic block 946 may be therefore programmed accordingly for making such determinations which may include for example calculating a change in the intensity of the reflected infrared light 111 over time to determine a change in direction of the object 54, 55 e.g. determining an increase in detected light intensity indicating the object 54, is approaching the at least one optical interface unit 44, 45 or determining a decrease in the detected light intensity indicating the at least one optical interface unit 44, 45 is moving away from the at least one optical interface unit 44, 45. Other configuration of the gesture engine digital interface control logic block 946 may be provided, as will be exemplified herein below such as for identification of black out conditions of the sensor 53. The infrared photometric sensor 920 may therefore provide for gesture sensing with less intensive data processing and filtering as compared with other gesture technologies (e.g., radar) and may provide more detailed information regarding the gesture or motion of the object 54, 55 as compared with capacitive sensors. Infrared photometric sensors 920, such as a photometric sensor for gesture and proximity detection enables ambient light rejection capability using analog filtering to improve operation of the infrared photometric sensor 920 in sunlight. It is recognized that the controller unit 56 may be programmed in lieu, or in conjunction with, the gesture engine digital interface control logic block 946 for processing light data e.g. angle and intensity angle for determining motion of the object 54, 55.

Now referring to FIG. 10 in addition to FIG. 9, controller unit 56 may include a sensor microcontroller 914 of the driver microcontroller and accent LED printed circuit board 910 and is shown to include a plurality of micro inputs 954 (e.g., serial data and serial clock to provide I2C communications with the infrared photometric sensor 920) and micro connections 955 (e.g., to power and ground). The sensor microcontroller 914 can be coupled to a communication link 48, such as a communication network (e.g. LIN bus or a CAN bus) of vehicle 10. The sensor microcontroller 914 receives signaling from the infrared photometric sensor 920, such as an interrupt signal and processes this IR sensor output signal and determine gestures or motion of the object 54, 55 (i.e., motion/gesture recognition), The sensor microcontroller 914 may alternatively and/or additional be configured to receive more detailed detected light data (e.g. angle information of the detected light 111 and/or intensity information of the detected light 111) from the infrared photometric sensor 920 and process this sensor data and determine gestures or motion of the object 54, 55 (i.e., motion/gesture recognition) using the gesture recognition algorithms locally stored in memory 915 and executed by a processor 917 of the sensor microcontroller 914. Controller unit 56 may then send a signal to the vehicle 10 (e.g., main electronic control unit 57, also referred to as a Body Control Module (BCM) to actuate the closure member (e.g., swing door 46) or directly to the control module of the system to be controlled e.g. electronic control module 752 for controlling actuator 722, 800.

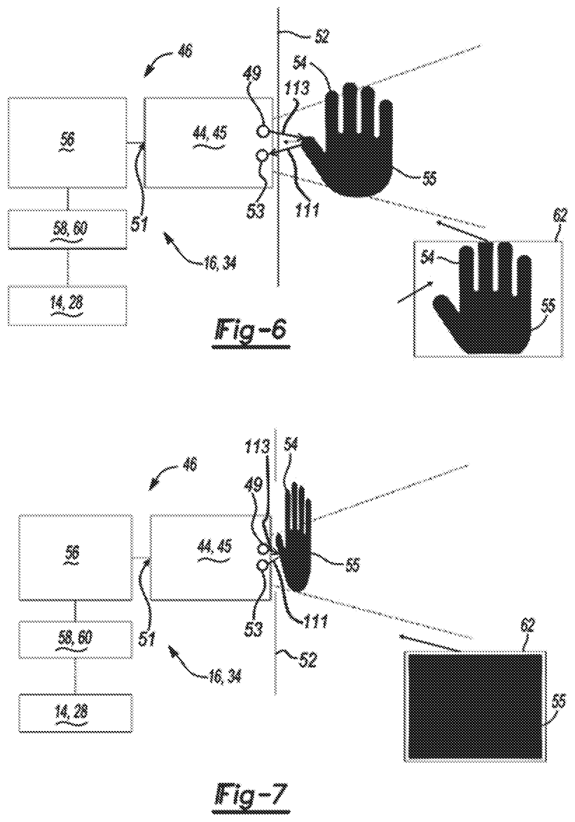

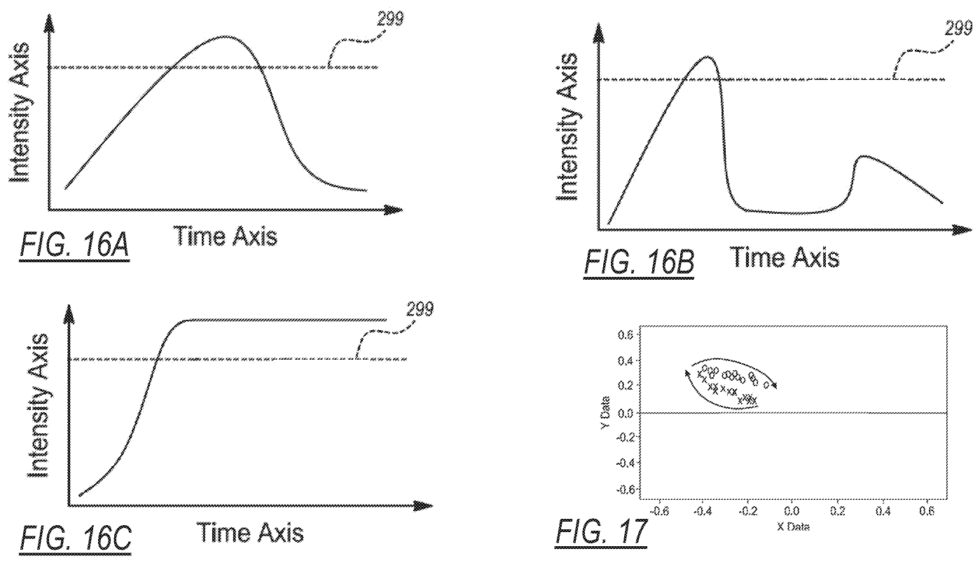

So, in operation seen in FIG. 4, the object 54, 55 (e.g., hand 55 or finger 54) can be visible in the field of view 62 detected by the at least one optical interface unit 44, 45. The controller unit 56 can use the at least one optical interface unit 44, 45 to track the approach of the object 54, 55 through an increase in the obscuring or blacking out of the field of view 62, as shown in FIG. 5. Then, as the object 54, 55 (e.g., hand 55 or finger 54) gets closer to the optical interface unit 44, 45 in FIG. 6, portions of the object 54, 55 are outside the field of view 62. In FIG. 7, when the object 54, 55 is even closer to the at least one optical interface unit 44, 45, the field of view 62 of the at least one optical interface unit 44, 45 is completely obscured, darkened, or blacked out because the hand or finger, for example, may be completely blocking all, or substantially all, or a predetermined portion of, other light received from the field of view of the at least one optical interface unit 44, 45, also referred to herein as a black out condition. Such a black out condition may be caused by a complete covering of the field of view 62 caused by for example a touch to the surface 52, for example a touch of a finger, or hand, or foot or other body part or object, or by an adjacent hovering adjacent to the surface 52 without a touch to the vehicle surface 52, for example a hovering of a finger, or hand, or foot or other body part or object to create a black out condition. A black out condition where no light 111 may be detected by sensor 53 may occur, such as shown in FIGS. 16B and 19, or a black out condition where the sensor 53 is placed in a saturation state due to an overloading of the sensor 53 by received light 111 as shown in FIGS. 16C and 21.

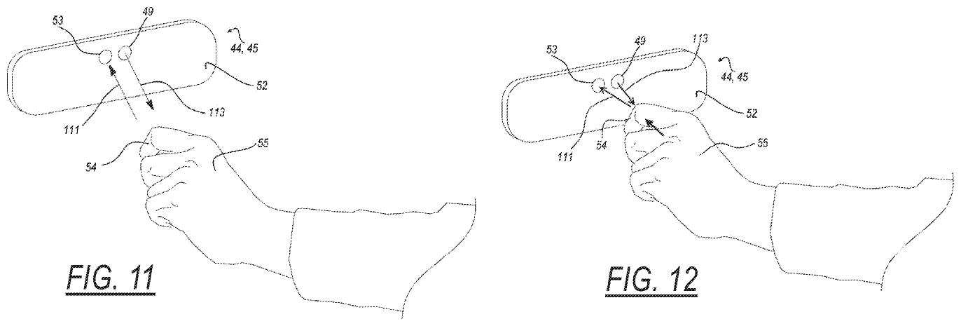

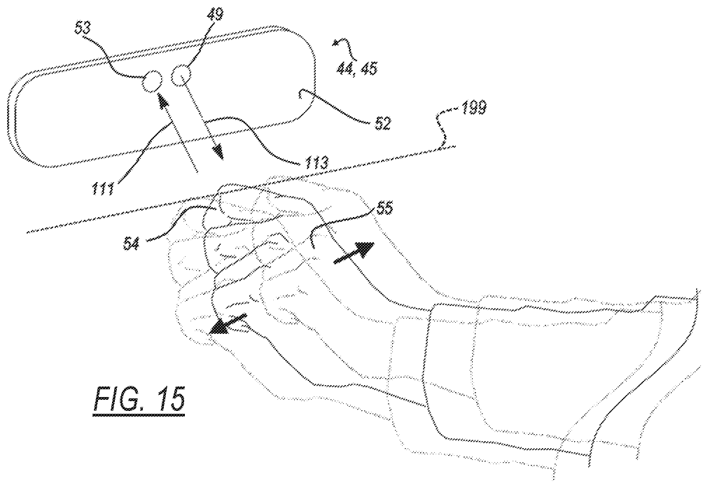

Now referring to FIGS. 11 to 15, an illustrative example of operation of the system 46 is now described. Referring initially to FIG. 11, illustrated is a view of the object 54, 55 as a hand approaching the at least one optical interface unit 44, 45 corresponding to the illustration of FIG. 4, such that the at least one optical interface unit 44, 45 may detect a change, indicating a motion of the object 54, 55, or no change indicating no motion of the object 54, 55, based on the characteristics of the received light 111 by the optical sensor 53, and for example the at least one optical interface unit 44, 45 may detect a change in intensity of the light 111 having been reflected off of or generated by the object 54, 55, such as an increase in the intensity of the light 111 detected due to the increase in amount of light reflection off of the object 54, 55 and towards the optical sensor 53 as the object 54, 55 decreases its distance towards, or in other words approaches, the at least one optical interface unit 44, 45, and for example presenting an increasing surface area for reflection of the transmitted light 113 when the at least one optical interface 44, 45 is configured as a reflective-type photoelectric sensor as seen in FIG. 11. The at least one optical interface unit 44, 45 may be initially configured for detecting a change in the angle received light 111 for detecting a motion of the object 54, 55 (see FIG. 15) indicating to the system 46 that an activation gesture performed by the object 54, 55, or in other words an activation first step gesture intended to initiate configuration of the system 46 for detecting a different characteristic of the received light 111, and for example configured for detecting a change in the intensity of the received light 111, in other words an activation second step gesture.

Now referring to FIG. 12, illustrated is a view of the object 54, 55 in closer proximity to the at least one optical interface unit 44, 45 than as shown in FIG. 11 and corresponding to the illustrations of FIGS. 5 and 6 and approaching the at least one optical interface unit 44, 45 but not entering into contact with the surface 52 or hovering closely there over to fully or at least partially obscure the field of view 62 of the at least one optical interface unit 44, 45 when adjacent the surface 52, for example by covering a pair of panel openings 936 with a finger 54, or one of the pair of panel openings 936 aligned with the optical sensor 53.

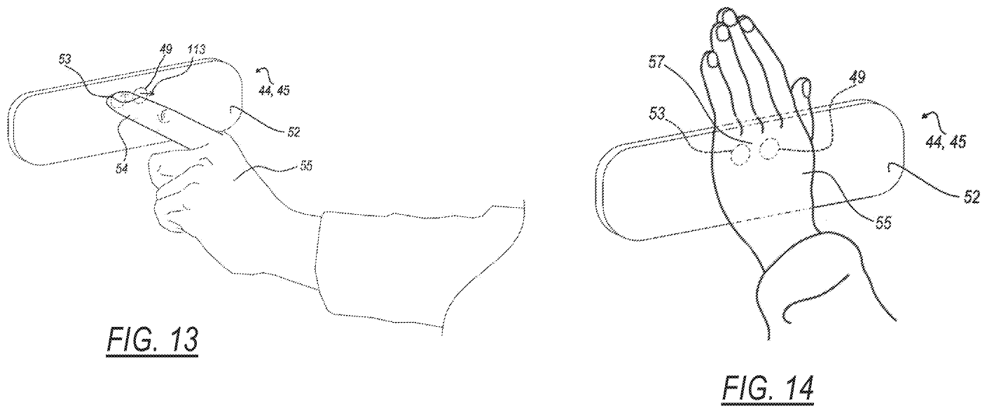

FIGS. 13 and 14, now referred to along with FIG. 7, illustrates the object 54, 55 in close proximity to the at least one optical interface unit 44, 45, but not necessarily in contact with the surface 52 to fully or partially obscure the field of view 62 of the at least one optical interface unit 44, 45. For example the field of view 62 of the sensor 53 may be interfered with by covering the sensor 53 e.g. one of the pair of panel openings 936 of the at least one optical interface unit 44, 45 with a finger 54 (see FIG. 13), or with a palm 57 of the hand 55 (see FIG. 14). The object 54, 55, 57 maybe in contact with the surface 52 to fully or partially obscure the field of view 62 of the at least one optical interface unit 44, 45 by contacting the surface 52, for example by covering one of or both the pair of panel openings 936 aligned with the sensor 53 with a finger 54, or palm 57 of the hand 55 as also shown in FIG. 7. The position of the object 54, 55 causing a full or partial obscuring of the field of view 62 of the at least one optical interface unit 44, 45 will depend on the viewing angle of the at least one optical interface unit 44, 45, for example the at least one optical interface unit 44, 45 configured with a narrower viewing angle may only require a close proximate hovering (e.g. non-contact) of the object 54, 55 adjacent to the at least one optical interface unit 44, 45, while the configuration of the at least one optical interface unit 44, 45 with a wider viewing angle may require a contact of the object 54, 55 with the surface 52, or a close hovering thereto, to fully enclose at least one of the pair of panel openings 936 for preventing light from being received by the optical sensor 53. The controller unit 56 coupled to the at least one optical interface unit 44, 45 may in response receive from the sensor output 51 sensor data which may be in the form of a interrupt signal indicating the activation condition e.g. the optical sensor 53 has been covered by the object 54, 55 for generating a command for transmission to the vehicle system such as the actuator 58, 60. The intent of the user to activate the vehicle system, such as the actuator 58, 60 for example, may be executed by using an optical sensor to detect an initial intent to activate the vehicle system e.g. the activation first step, followed by a confirmatory intent to activate the vehicle system e.g. the activation second step. A two part activation for an optical based sensor is therefore provided to discern from false triggering due to random motion in the field of the view of the optical sensor, false triggering due to ice and debris build up on the vehicle surface 52, false triggering due to unintentional gesture such as a user leaning on the surface 52. Robustness for identifying triggering events for an optical sensor is therefore provided which may be achieved by operating the system 46 in modes for identifying different characteristics of light during an activation sequence event consisting of an activation gesture, and followed by a simple confirmatory gesture e.g. pressing on a vehicle surface 52 for covering an optical sensor 53. No moving parts are therefore required, providing a sealable state to surface 52, wakeup range during the activation first step may be increased as compared to other technologies such as capacitive based sensors, and non-complex detection algorithms and circuitry are provided as compared to radar based (e.g. Doppler, FMCVV) sensors.

Now referring to FIG. 15, there is illustrated a motion of the object 55 as a hand performing a gesture shown as a left and right swiping of the hand during the activation first step. The at least one optical interface unit 44, 45 and/or controller unit 56 may be configured to detect such a gesture being performed at a threshold distance indicated as a dashed line 199 away from at least one optical interface unit 44, 45, which may be recognized based on the detected intensity level of the light 111 received by sensor 53 in conjunction with the light angle change detection of the reflected light 111 when the object 55 is at such a threshold distance.

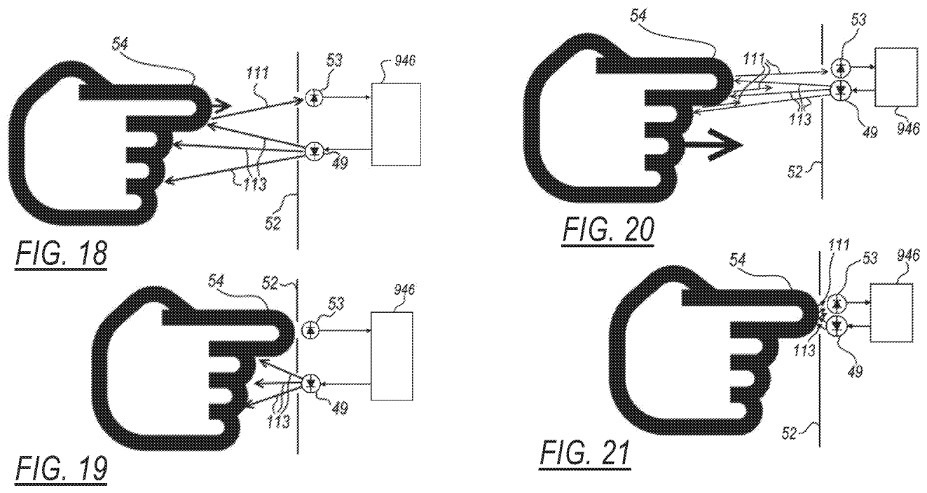

Now referring to FIGS. 16A to 16C in addition to FIG. 9, there are shown graphs of a received intensity over time of a channel 942 of the infrared photometric sensor 53 corresponding to different motions or positions of the object 54, 55. The infrared photometric sensor 53 intensity points plotted on a graph for illustration (i.e., intensity data received) for each of the four channels 942. For example, FIG. 16A represents monitored data information showing a detected intensity increasing over time, the intensity crossing a threshold indicated by line 299 for a period of time, and then dropping to below the threshold 299 thereafter. Such a detected intensity graph may represent the object 54, 55 approaching the sensor 53 to a given distance from the surface 52, the object remaining at such a distance, and then the object moving away from the surface 52. The at least one optical interface unit 44, 45 and/or controller unit 56 may be configured to compare this intensity sequence with a pre-stored sequence for recognizing the motion of the object 54, 55 as represented by the detected light intensity data. FIG. 16B represents captured data information showing a detected intensity initially increasing over time, the intensity crossing a threshold indicated by line 299 and sharply dropping to a low or non-intense level, and rapidly spiking for a short duration thereafter. Such a detected intensity graph may represent the object 54, 55 initially approaching the sensor 53 as shown in FIG. 18 to a final given distance from the surface 52 as shown in FIG. 19, the object 54, 55 remaining at such a distance causing the sensor 53 to enter into a nonlight detection state, indicated by the plateau portion of the intensity curve between the two intensity peaks, and then the object 54, 55 remaining at this distance to maintain the sensor 53 in a nonlight detection state or in a blackout condition. In the non-light detection, the finger 54 as shown in FIG. 19 completely covers the sensor 53 for preventing any light, such as IR light from the source 49 stimulating the sensor 53. The at least one optical interface unit 44, 45 and/or controller unit 56 may be configured to compare this intensity sequence with a pre-stored sequence for recognizing the motion of the object 54, 55 as represented by the detected light intensity data. FIG. 16C represents captured data information of the sensor 53 showing a detected intensity initially increasing over time, the intensity crossing a threshold indicated by line 299 for a period of time, and then remaining above the threshold 299 thereafter. Such a detected intensity graph may represent the object 54, 55 initially approaching the sensor 53 as shown in FIG. 19 to a given distance from the surface 52 as shown in FIG. 20, the object remaining at such a distance causing the sensor 53 to enter into a saturation state indicated by the plateau portion of the intensity curve after crossing the threshold 299, and then the object 54, 55 remaining at this distance to maintain the sensor 53 in a saturation state. In the saturation state since the finger 54 is completely reflecting all of the light 113 emitted by source 49 as seen in FIG. 20, the sensor 53 is caused to receive such reflected light 11 and cause a clipping of the sensor reading or saturation of the sensor 53. The at least one optical interface unit 44, 45 and/or controller unit 56 may be configured to compare this intensity sequence with a pre-stored sequence for recognizing the motion of the object 54, 55 as represented by the detected light intensity data.

Now referring to FIG. 17, the infrared photometric sensor 53 produces a position points plotted on a position graph for illustration (i.e., light angle data received) for each of the four channels 942. These position graphs allow for the determination of gestures like left to right, right to left, top to bottom and bottom to top, for example. As best shown in FIG. 17, the received position and intensity data received from the infrared photometric sensor 53, 920 can be matched for determining a valid gesture using a gesture algorithm (e.g., executed by the sensor microcontroller 914) to determine a swipe gesture (as shown in FIG. 15). For example the algorithm may be configured with steps including processing the light angle information corresponding to the object 54, 55 to determine the object moving in one direction e.g. left relative to the sensor 53 is shown in FIG. 17 by Xs (e.g. determining a change in the X points positions towards a negative direction over time), the step including processing the light angle information corresponding to the object 54, 55 then moving from in an opposite direction e.g. right is shown as Os. e.g. determining a change in the o points positions towards a positive direction over time). The at least one optical interface unit 44, 45 and/or controller unit 56 may be configured to compare this light angle data point set, or position sequence with a pre-stored sequence of position data points for recognizing the motion of the object 54, 55 as represented by the detected light intensity data.

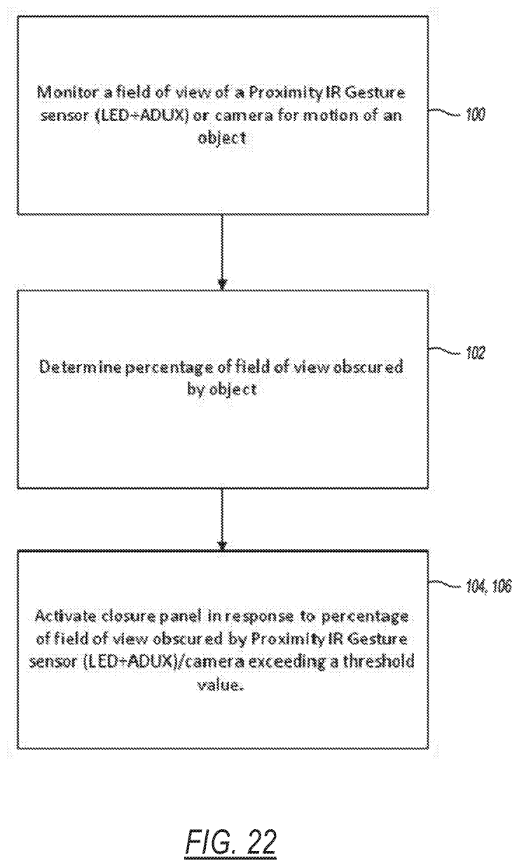

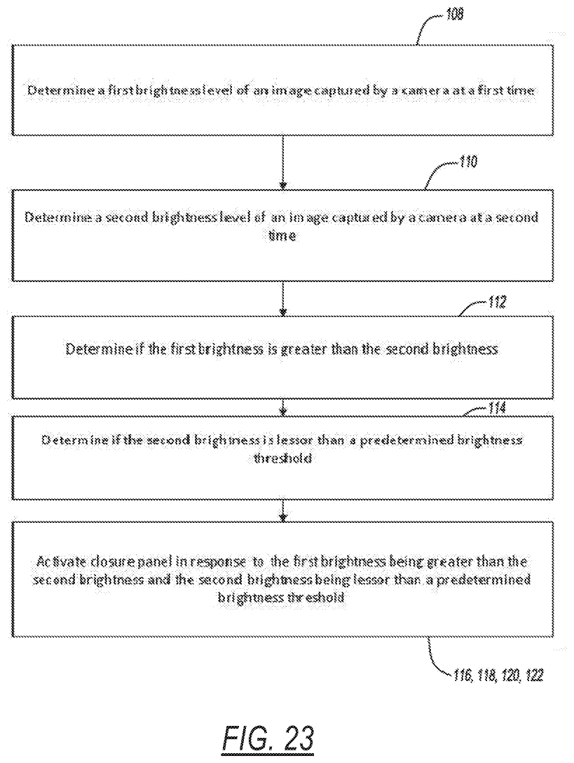

As best shown in FIGS. 22 and 23, a method of operating a closure panel 14, 28 of a vehicle 10 is also provided. In general, the method includes the step of monitoring at least one optical interface unit 44, 45 for motion of an object 54, 55. The method continues with the step of determining whether the motion of the object 54, 55 matches a predetermined touch or gesture command. Next, the method includes the step of controlling an actuator 58, 60 of the closure panel 14, 28 in response to the touch or gesture matching the predetermined touch or gesture command. Specifically, the step of controlling an actuator 58, 60 of the closure panel 14, 28 in response to the touch or gesture matching the predetermined touch or gesture command can include latching or unlatching (or unlocking) the closure panel 14, 28 of the vehicle 10 relative to the body 12 of the vehicle 10, for example.

As discussed above, the at least one optical interface unit 44, 45 can be an infrared proximity sensor 44 or a camera 45 having a field of view 62. So, the method further includes the step of tracking an increasing obscuring of the field of view 62 over time and discerning a pattern of the object 54, 55 chosen from the group consisting of a finger 54, a hand 55, or a gesture for false triggering mitigation due to environmental factors. In more detail, as shown in FIG. 20, the method can include the steps of 100 monitoring the field of view 62 of the infrared proximity sensor 44 or camera 45 to detect the motion of the object 54, 55 and 102 determining a percentage of the field of view 62 obscured by the object 54, 55. Next, the method includes the step of 104 determining whether the percentage of the field of view 62 obscured by the object 54, 55 exceeds a predetermined obscurity threshold. The method can also include the step of 106 activating the actuator 58, 60 in response to the percentage of the field of view 62 obscured by the object 54, 55 exceeding the predetermined obscurity threshold.

If the at least one optical interface unit 44, 45 is a camera 45 configured to capture imaging of a field of view 62, the method can include the steps shown in FIG. 19. So, the method further includes the step of 108 determining a first brightness level of the image captured by the camera 45 at a first time. Next, 110 determining a second brightness level of another image captured by the camera 45 at a second time. The method continues with the step of 112 determining whether the first brightness is greater than the second brightness. The next step of the method is 114 determining whether the second brightness is greater than a predetermined brightness threshold. The method can also include the steps of 116 analyzing the imaging captured by the camera 45 to determine three dimensional light intensity data corresponding to the object 54, 55 and 118 determining whether the three dimensional light intensity data matches the predetermined touch or gesture command.

The method proceeds with the step of 120 activating the actuator 58, 60 in response to determining that the first brightness is greater than the second brightness and determining the second brightness is greater than the predetermined brightness threshold. The method can also include the step of 122 filtering the imaging captured by the camera 45 to avoid false control of the actuator 58, 60 (e.g., using the controller unit 56).

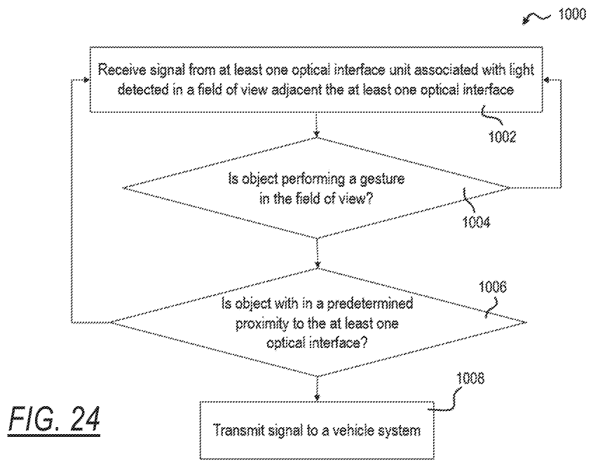

Now referring to FIG. 24, there is illustrated an illustrated algorithm executed by the at least one optical interface unit 44, 45 or controller unit 56 programmed accordingly for controlling a vehicle system illustrated as a method 1000, the method 1000 including the steps of receiving a signal from at least one optical interface unit associated with light detected in a field of view adjacent the at least one optical interface 1002, determining if the object is performing a gesture in the field of view 1004, and if so, next determining if the object is within a predetermined proximity to the at least one optical interface 1006, and if so, next transmitting a command signal to a vehicle system 1008, and if not, returning to the step of receiving a signal from at least one optical interface unit associated with light detected in a field of view adjacent the at least one optical interface 1002.

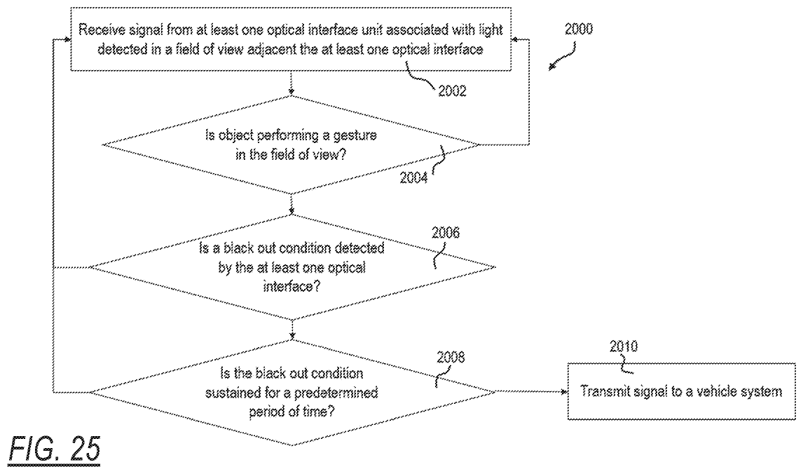

Now referring to FIG. 25, there is illustrated another illustrated algorithm executed by the at least one optical interface unit 44, 45 or controller unit 56 programmed accordingly for controlling a vehicle system illustrated as a method 2000, the method 2000 including the steps of receiving a signal from at least one optical interface unit associated with light detected in a field of view adjacent the at least one optical interface 2002, determining if the object is performing a gesture in the field of view 2004, and if so, next determining if a black out condition detected by the at least one optical interface 2006, and if so, next determining if the black out condition is sustained for a predetermined period of time 2008, and if not, returning to the step of receiving a signal from at least one optical interface unit associated with light detected in a field of view adjacent the at least one optical interface 2002, and if yes, next transmitting a command signal to a vehicle system 2010.

What is claimed is:

1. A system for operating a closure panel of a vehicle, comprising:
at least one optical interface unit for detecting motion of an object; and
a controller unit coupled to the at least one optical interface unit and in communication with an actuator for operating the closure panel, the controller unit configured to:
monitor the at least one optical interface unit to detect the motion of the object,
determine whether the motion of the object matches a predetermined touch or gesture command, and
control the actuator in response to the touch or gesture matching the predetermined touch or gesture command.

2. The system as set forth in claim 1, wherein the at least one optical interface unit is an infrared proximity sensor or camera having a field of view.

3. The system as set forth in claim 2, wherein the controller unit is further configured to track an increasing obscuring of the field of view over time and discern a pattern of the object chosen from the group consisting of a finger, a hand, or a gesture for false triggering mitigation due to environmental factors.

4. The system as set forth in claim 2, wherein the controller unit is further configured to:
monitor the field of view of the infrared proximity sensor or camera to detect the motion of the object,
determine a percentage of the field of view obscured by the object,
determine whether the percentage of the field of view obscured by the object exceeds a predetermined obscurity threshold, and
activate the actuator in response to the percentage of the field of view obscured by the object exceeding the predetermined obscurity threshold.

5. The system as set forth in claim 1, wherein the at least one optical interface unit is a camera configured to capture imaging of a field of view.

6. The system as set forth in claim 5, wherein the controller unit is further configured to:
determine a first brightness level of an image captured by the camera at a first time,
determine a second brightness level of another image captured by the camera at a second time, and
determine whether the first brightness is greater than the second brightness.

7. The system as set forth in claim 6, wherein the controller unit is further configured to:
determine whether the second brightness is greater than a predetermined brightness threshold, and
activate the actuator in response to determining that the first brightness is greater than the second brightness and determining the second brightness is greater than the predetermined brightness threshold.

8. The system as set forth in claim 5, wherein the controller unit is further configured to filter the imaging captured by the camera to avoid false control of the actuator.

9. The system as set forth in claim 5, wherein the controller unit is further configured to:
analyze the imaging captured by the camera to determine three dimensional light intensity data corresponding to the object, and
determine whether the three dimensional light intensity data matches the predetermined touch or gesture command.

10. The system as set forth in claim 1, wherein the at least one optical interface unit is disposed behind a surface of the vehicle chosen from the group consisting of a window of the vehicle, an applique attached to the vehicle, or an exterior of a handle of the vehicle.

11. The system as set forth in claim 1, wherein the actuator is a latch actuator for latching and unlatching the closure panel of the vehicle relative to a body of the vehicle.

12. The system as set forth in claim 1, wherein the actuator is a lock actuator for locking and unlocking the closure panel of the vehicle relative to a body of the vehicle.

13. A method of operating a closure panel of a vehicle, comprising the steps of:
monitoring at least one optical interface unit for motion of an object;
determining whether the motion of the object matches a predetermined touch or gesture command; and
controlling an actuator of the closure panel in response to the touch or gesture matching the predetermined touch or gesture command.

14. The method as set forth in claim 13, wherein the at least one optical interface unit is an infrared proximity sensor or a camera having a field of view and further including the step of tracking an increasing obscuring of the field of view over time and discerning a pattern of the object chosen from the group consisting of a finger, a hand, or a gesture for false triggering mitigation due to environmental factors.

15. The method as set forth in claim 14, further including the steps of:
monitoring the field of view of the infrared proximity sensor or camera 45 to detect the motion of the object;
determining a percentage of the field of view obscured by the object;
determining whether the percentage of the field of view obscured by the object exceeds a predetermined obscurity threshold; and
activating the actuator in response to the percentage of the field of view obscured by the object exceeding the predetermined obscurity threshold.

16. The method as set forth in claim 13, wherein the at least one optical interface unit is a camera configured to capture imaging of a field of view and the method further includes the steps of:
determining a first brightness level of the image captured by the camera at a first time;
determining a second brightness level of another image captured by the camera at a second time; and
determining whether the first brightness is greater than the second brightness.

17. The method as set forth in claim 16, further including the steps of:
determining whether the second brightness is greater than a predetermined brightness threshold; and
activating the actuator in response to determining that the first brightness is greater than the second brightness and determining the second brightness is greater than the predetermined brightness threshold.

18. The method as set forth in claim 13, wherein the at least one optical interface unit is a camera configured to capture imaging of a field of view and the method further includes the step of filtering the imaging captured by the camera to avoid false control of the actuator.

19. The method as set forth in claim 13, wherein the at least one optical interface unit is a camera configured to capture imaging of a field of view and the method further includes the steps of:
analyzing the imaging captured by the camera to determine three dimensional light intensity data corresponding to the object; and
determining whether the three dimensional light intensity data matches the predetermined touch or gesture command.

20. A system for operating a closure panel of a vehicle, comprising:
at least one optical interface unit for monitoring the light from a field of view; and
a controller unit coupled to the at least one optical interface unit and in communication with an actuator for operating the closure panel, the controller unit configured to:
monitor the at least one optical interface unit,
determine a black out condition of the optical interface unit, and
control the actuator in response to determining the black out condition of the optical interface unit.
